(19) United States
(12) Patent Application Publication
(10) Pub. No.: US 2014/0070110 A1
(43) Pub. Date: Mar. 13, 2014

(54) ATOM PROBE MEASURING APPARATUS AND METHOD

(71) Applicant: KABUSHIKI KAISHA TOSHIBA, Tokyo (JP)

(72) Inventors: Katsuyuki KITAMOTO, Yokkaichi-shi (JP); Haruko AKUTSU, Yokosuka-shi (JP)

(21) Appl. No.: 13/781,284

(22) Filed: Feb. 28, 2013

(30) Foreign Application Priority Data
Sep. 7, 2012 (JP) 2012-197515

(51) Int. Cl. G01N 23/00

(52) U.S. Cl. CPC G01N 23/00
USPC 250/393

(57) ABSTRACT

In one embodiment, an atom probe measuring apparatus includes an X-ray source configured to generate an X-ray. The apparatus further includes an optical system configured to irradiate a sample with the X-ray. The apparatus further includes a power supply configured to apply a voltage to the sample. The apparatus further includes a detector configured to detect ions evaporated from the sample by irradiating the sample with the X-ray with applying the voltage to the sample.

### CROSS REFERENCE TO RELATED APPLICATION

This application is based upon and claims the benefit of priority from the prior Japanese Patent Application No. 2012-197515, filed on Sep. 7, 2012, the entire contents of which are incorporated herein by reference.

### FIELD

Embodiments described herein relate to an atom probe measuring apparatus and method.

### BACKGROUND

For example, a conventional atom probe measuring method intermittently irradiates a tip of a sample processed into a needle-like shape with laser light with applying a high voltage to the sample, thereby evaporating atoms one by one from the tip of the sample so as to be ions (this is called “field evaporation”). In this case, the field evaporation is induced by field induction caused by voltage or photo-excitation caused by laser light. Furthermore, the conventional method identifies arrangement of the atoms in the sample prior to the field evaporation by measuring the mass and arriving positions of the ions. According to this method, it is possible, by inducing the field evaporation by voltage with being supplemented with laser light, to analyze a semiconductor sample and an insulator sample that are difficult to analyze only by the field evaporation caused by voltage. However, the sample including a high melting point material layer such as a heavy metal material layer has difficulty because a variation in field evaporation threshold due to a difference in composition of the material is large. Therefore, it is still difficult to analyze such sample through the conventional method.

### BRIEF DESCRIPTION OF THE DRAWINGS

FIG. 1 is a schematic diagram showing a configuration of an atom probe measuring apparatus of a first embodiment; and

FIG. 2 is a schematic diagram showing a configuration of an atom probe measuring apparatus of a second embodiment.

### DETAILED DESCRIPTION

Embodiments will now be explained with reference to the accompanying drawings.

In one embodiment, an atom probe measuring apparatus includes an X-ray source configured to generate an X-ray. The apparatus further includes an optical system configured to irradiate a sample with the X-ray. The apparatus further includes a power supply configured to apply a voltage to the sample. The apparatus further includes a detector configured to detect ions evaporated from the sample by irradiating the sample with the X-ray with applying the voltage to the sample.

### First Embodiment

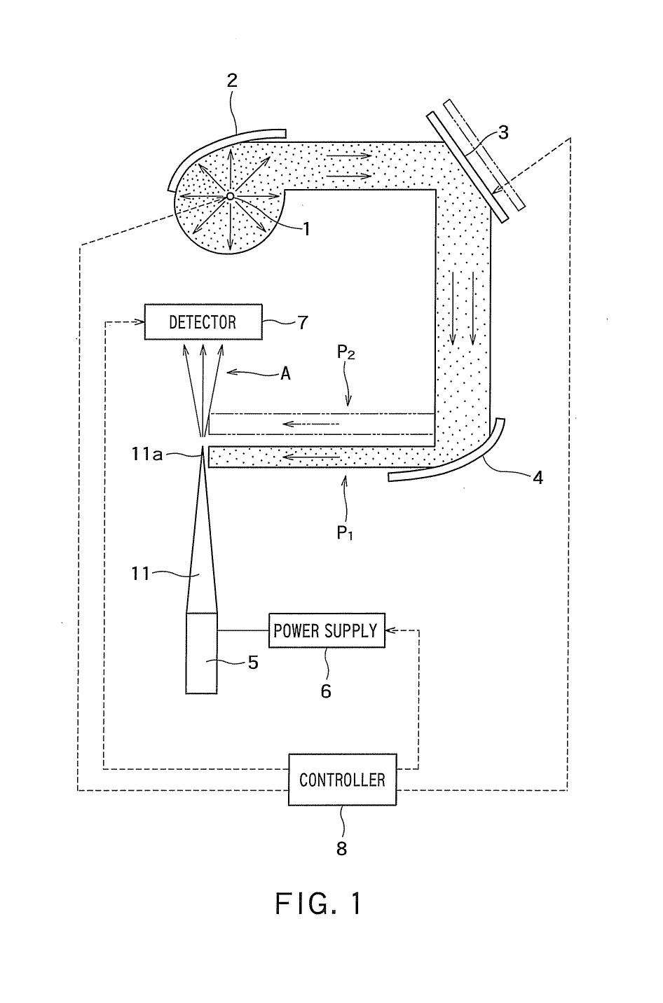

FIG. 1 is a schematic diagram showing a configuration of an atom probe measuring apparatus of a first embodiment. The apparatus of FIG. 1 includes an X-ray source 1, a first mirror 2, a second mirror 3, a third mirror 4, a sample holder 5, a power supply 6, a detector 7, and a controller 8. An optical system including the first to third mirrors 2 to 4 is an example of an optical system of the disclosure. The second mirror 3 is an example of a first optical device, and the first and third mirrors 2 and 4 are examples of a second optical device.

An X-ray generated from the X-ray source 1 is reflected at a reflective surface of the first mirror 2 so as to be converged and turned into a parallel X-ray. The X-ray source 1 may be a light source generating an X-ray at a specific wavelength, or may be a light source generating a white X-ray. In the former case, the X-ray source 1 may be able to change the wavelength of the X-ray. The first mirror 2 is, for example, a multilayer mirror having a hyperboloidal reflective surface. The hyperboloidal reflective surface is advantageous in that preferable converging performance can be obtained with a small reflective surface.

The X-ray from the reflective surface of the first mirror 2 is reflected at a reflective surface of the second mirror 3. The second mirror 3 is, for example, a multilayer mirror having a planar reflective surface. The second mirror 3 includes a piezoelectric device for changing an optical path of the X-ray by vibrating the reflective surface of the second mirror 3.

The X-ray from the reflective surface of the second mirror 3 is reflected at a reflective surface of the third mirror 4 so as to be converged. The third mirror 4 is, for example, a multilayer mirror having a hyperboloidal reflective surface.

A sample 11 is processed into a needle-like shape and hold by the sample holder 5. A tip 11a of the sample 11 is irradiated with the X-ray from the reflective surface of the third mirror 4. Examples of a material forming the sample 11 include a semiconductor material such as silicon or an insulator material such as ceramics. The sample 11 may include a high melting point material layer such as a heavy metal material layer (for example, a tungsten layer). A high voltage pulse is applied to the sample 11 held by the sample holder 5 from the power supply 6.

In the present embodiment, the tip 11a of the sample 11 is irradiated with the X-ray from the X-ray source 1 via the first to third mirrors 2 to 4 with applying a voltage from the power supply 6 to the sample 11. As a result, atoms are evaporated one by one from the tip 11a of the sample 11 so as to be ions, as shown by arrows A. The detector 7 detects the ions evaporated from the sample 11. The detector 7 is, for example, a two-dimensional detector.

In the present embodiment, the optical path of the X-ray is changed by vibrating the reflective surface of the second mirror 3, so that the sample 11 is intermittently irradiated with the X-ray. FIG. 1 schematically shows a state in which the optical path changes between P₁ and P₂ due to this vibration. The sample 11 is irradiated with the X-ray that travels along the optical path P₁, but is not irradiated with the X-ray that travels along the optical path P₂. Therefore, the sample 11 of the present embodiment is intermittently irradiated with the X-ray. Accordingly, the sample 11 of the present embodiment can be irradiated with a pulsed X-ray.

The controller 8 is a device that controls an operation of the atom probe measuring apparatus. For example, the controller 8 is a computer. For example, the controller 8 controls a timing at which the X-ray is generated by the X-ray source 1, an operation of the piezoelectric device for vibrating the second mirror 3, switching between ON and OFF of the power supply 6, a detecting operation of the detector 7 and the like.

As described above, the ray used for irradiating the sample 11 in the present embodiment is an X-ray instead of laser light. Hereinafter, effects of using the X-ray will be described.

When the sample 11 is irradiated with the X-ray, electrons in the atoms forming the sample 11 are excited and emitted. When the sample 11 is irradiated with the X-ray, not only outer-shell electrons but also inner-shell electrons of the atoms of the sample 11 can be emitted, because the X-ray has higher efficiency of exciting the electrons than laser light. Accordingly, using the X-ray can facilitate evaporation of the atoms of a high melting point material such as a heavy metal material. Therefore, according to the present embodiment, the atom probe measuring apparatus can also be applied to the sample 11 including the high melting point material later.

When the laser light is used, energy of the laser light is converted into thermal vibration energy of lattice in the sample 11, so that spatial resolution and mass resolution of the atom probe measuring apparatus are deteriorated. On the other hand, when the X-ray is used, generation of lattice vibration can be reduced, so that the spatial resolution and the mass resolution of the atom probe measuring apparatus can be improved.

Next, various modifications of the atom probe measuring apparatus of the present embodiment will be described.

The apparatus of the present embodiment includes two mirrors (the first and third mirrors 2 and 4) as mirrors having a converging function (converging mirrors). However, the number of converging mirrors in the apparatus of the present embodiment may be one, or may be three or more. The shape of the reflective surface of the converging mirrors may be a shape other than a hyperboloid.

The second mirror 3 of the present embodiment vibrates its reflective surface with the piezoelectric device that converts electric energy into vibration energy. However, the reflective surface may vibrated with another device. For example, the second mirror 3 of the present embodiment may vibrate the reflective surface with a device that converts thermal energy of received light into vibration energy. The shape of the reflective surface of the second mirror 3 may be a shape other than a plane.

Although the first to third mirrors 2 to 4 in the present embodiment are arranged in an order of the first mirror 2, the second mirror 3, and the third mirror 4, the first to third mirrors 2 to 4 may be arranged in a different order. For example, the first to third mirrors 2 to 4 may be arranged in an order of the first mirror 2, the third mirror 4, and the second mirror 3.

Although the optical system in the apparatus of the present embodiment includes the first to third mirrors 2 to 4, the optical system may include another optical device. Specific examples of such an optical device include lenses such as a converging lens, filters such as a high pass filter, a low pass filter and a band pass filter, polarizers, and analyzers.

Energy of the X-ray with which the sample 11 is irradiated may be at any value. However, if the energy of the X-ray is too low, materials that can be evaporated are limited. On the other hand, if the energy of the X-ray is too high, absorbing efficiency of the X-ray is reduced. Therefore, to improve the absorbing efficiency while allowing many materials to be evaporated, the energy of the X-ray with which the sample 11 is irradiated is set to 1.2 keV to 18.0 keV in the present embodiment. However, the X-ray having energy lower than 1.2 keV or an X-ray having energy higher than 18.0 keV can also be used in the present embodiment.

A material forming the sample 11 may be any material. An example of the sample 11 includes a multilayer sample that includes a high melting point material layer such as a heavy metal material can layer. This multilayer sample may include only the high melting point material layer, or may include the high melting point material layer and a low melting point material layer. The high melting point material may be an elemental metal containing a heavy metal element, or may be an alloy or a compound containing a heavy metal element.

The controller 8 of the present embodiment can carry out various controls, in addition to the controls illustrated above, regarding the operation of the atom probe measuring apparatus. For example, the controller 8 of the present embodiment can carry out a control to synchronize a vibrating timing of the second mirror 3 and a detecting timing of the detector 7.

For example, the apparatus of the present embodiment detects ions evaporated from the sample 11 with the detector 7 to measure the mass and arriving positions of the ions. This makes it possible to identify arrangement of atoms in the sample 11 prior to the field evaporation.

Finally, Effects of the first embodiment will be described.

As described above, in the atom probe measurement of the present embodiment, the sample 11 is irradiated with the X-ray while the voltage is applied to the sample 11, so that the atoms forming the sample 11 are evaporated to be ions. In the present embodiment, using the X-ray makes it possible to evaporate the atoms in a high melting point material such as a heavy metal material with ease. Therefore, according to the present embodiment, the atom probe measurement can also be applied to the sample 11 including the high melting point material layer.

### Second Embodiment

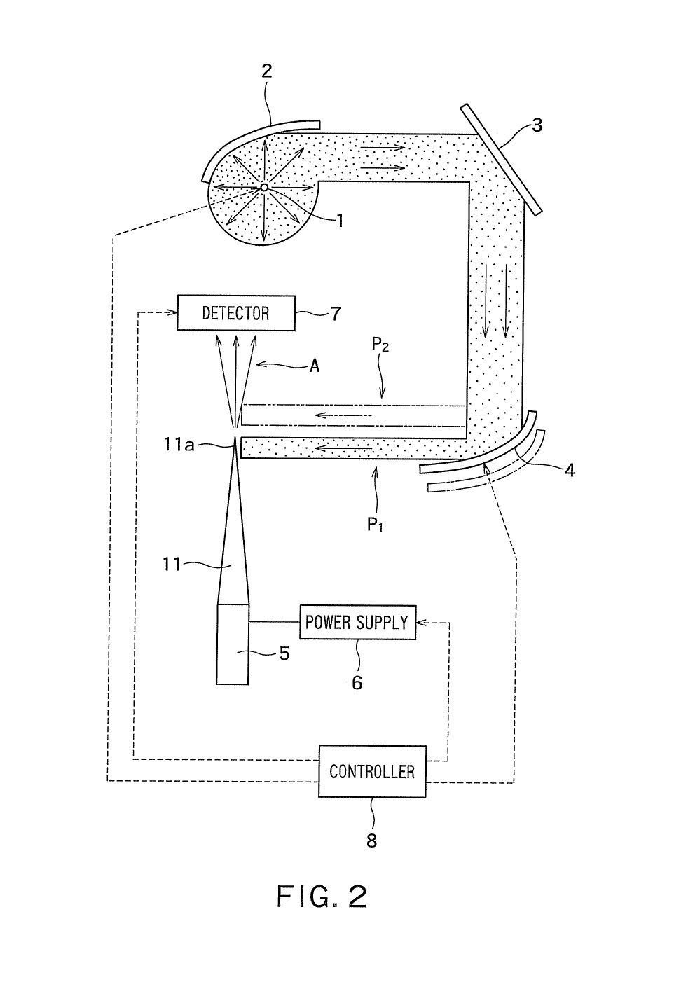

FIG. 2 is a schematic diagram showing a configuration of an atom probe measuring apparatus of a second embodiment.

The piezoelectric device in the present embodiment is provided on the third mirror 4, instead of the second mirror 3. Therefore, the third mirror 4 of the present embodiment can change the optical path of the X-ray by vibrating its reflective surface with the piezoelectric device. Furthermore, the third mirror 4 of the present embodiment has a hyperboloidal reflective surface, similarly to the third mirror 4 of the first embodiment. Therefore, the third mirror 4 of the present embodiment can reflect the X-ray at the reflective surface so as to converge the X-ray. The shape of the reflective surface of the third mirror 4 may be a shape other than a hyperboloid.

In the present embodiment, the tip 11a of the sample 11 is irradiated with the X-ray from the X-ray source 1 via the first to third mirrors 2 to 4 with applying the voltage from the power supply 6 to the sample 11. As a result, the atoms are evaporated from the tip 11a of the sample 11 so as to be ions, as shown by arrows A. The detector 7 detects the ions evaporated from the sample 11.

In the present embodiment, the optical path of the X-ray is changed by vibrating the reflective surface of the third mirror 4, so that the sample 11 is intermittently irradiated with the X-ray. FIG. 2 schematically shows a state in which the optical path changes between P₁ and P₂ due to this vibration. The sample 11 is irradiated with the X-ray that travels along the optical path P₁, but is not irradiated with the X-ray that travels along the optical path P₂. Therefore, the sample 11 of the present embodiment is intermittently irradiated with the X-ray. Accordingly, the sample 11 of the present embodiment can be irradiated with a pulsed X-ray, similarly to the first embodiment.

In the present embodiment, the optical path of the X-ray may be changed by rotating the reflective surface of the third mirror 4, instead of by vibrating the reflective surface of the third mirror 4, to intermittently irradiate the sample 11 with the X-ray. In this case, the reflective surface of the third mirror 4 is, for example, rotated about a rotation axis that extends in a direction perpendicular to a paper of FIG. 2.

Finally, effects of the second embodiment will be described.

As described above, in the atom probe measurement of the present embodiment, the sample 11 is irradiated with the X-ray while the voltage is applied to the sample 11, so that atoms forming the sample 11 are evaporated to be ions. In the present embodiment, using the X-ray makes it possible to evaporate the atoms of a high melting point material such as a heavy metal material with ease. Therefore, according to the present embodiment, the atom probe measurement can also be applied to the sample 11 including the high melting point material layer, similarly to the first embodiment.

Although a mirror having a vibrating function and a mirror having a converging function are arranged separately in the first embodiment, the third mirror 4 in the second embodiment has both the vibrating function and the converging function. Therefore, the optical system in the second embodiment may be configured without using the second mirror 3. In this way, according to the second embodiment, the number of components configuring the optical system can be reduced by providing a mirror having both the vibrating function and the converging function.

On the other hand, the second mirror 3 in the first embodiment has a vibrating function, and the first and third mirrors 2 and 4 in the first embodiment have converging functions. Therefore, the reflective surface of the second mirror 3 is planar because the second mirror 3 does not need to have the converging function. For example, the second mirror 3 having the planar reflective surface yields advantages in that control of changing the optical path of the X-ray through vibration is facilitated, and control of a timing at which the sample 11 is irradiated with the X-ray and a timing at which the sample 11 is not irradiated with the X-ray is facilitated with high precision. The shape of the reflective surface of the second mirror 3 of the first embodiment may be a shape other than a plane as long as that shape facilitates the control of changing the optical path.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

1. An atom probe measuring apparatus comprising:
an X-ray source configured to generate an X-ray;
an optical system configured to irradiate a sample with the X-ray;
a power supply configured to apply a voltage to the sample; and
a detector configured to detect ions evaporated from the sample by irradiating the sample with the X-ray with applying the voltage to the sample.

2. The apparatus of claim 1, wherein the optical system comprises a first optical device having a reflective surface reflecting the X-ray, and the sample is intermittently irradiated with the X-ray by changing an optical path of the X-ray by vibrating or rotating the reflective surface.

3. The apparatus of claim 2, wherein the optical system further comprises a second optical device having a reflective surface reflecting the X-ray such that the X-ray is converged.

4. The apparatus of claim 3, wherein the reflective surface of the second optical device is a hyperboloidal surface.

5. The apparatus of claim 2, wherein the first optical device reflects the X-ray at the reflective surface such that the X-ray is converged.

6. The apparatus of claim 5, wherein the reflective surface of the first optical device is a hyperboloidal surface.

7. The apparatus of claim 2, wherein the first optical device comprises a piezoelectric device configured to change the optical path by vibrating the reflective surface.

8. The apparatus of claim 2, wherein the first optical device vibrates the reflective surface with a device configured to convert thermal energy of received light into vibration energy.

9. The apparatus of claim 1, wherein energy of the X-ray with which the sample is irradiated is 1.2 keV to 18.0 keV.

10. The apparatus of claim 1, wherein the sample comprises a material containing a heavy metal element.

11. An atom probe measuring method comprising:
generating an X-ray to irradiate a sample;
evaporating ions from the sample by irradiating the sample with the X-ray with applying a voltage to the sample; and
detecting the ions evaporated from the sample.

12. The method of claim 11, wherein an optical system to irradiate the sample with the X-ray comprises a first optical device having a reflective surface reflecting the X-ray, and the sample is intermittently irradiated with the X-ray by changing an optical path of the X-ray by vibrating or rotating the reflective surface.

13. The method of claim 12, wherein the optical system further comprises a second optical device having a reflective surface reflecting the X-ray such that the X-ray is converged.

14. The method of claim 13, wherein the reflective surface of the second optical device is a hyperboloidal surface.

15. The method of claim 12, wherein the first optical device reflects the X-ray at the reflective surface such that the X-ray is converged.

16. The method of claim 15, wherein the reflective surface of the first optical device is a hyperboloidal surface.

17. The method of claim 12, wherein the first optical device comprises a piezoelectric device configured to change the optical path by vibrating the reflective surface.

18. The method of claim 12, wherein the first optical device vibrates the reflective surface with a device configured to convert thermal energy of received light into vibration energy.

19. The method of claim 11, wherein energy of the X-ray with which the sample is irradiated is 1.2 keV to 18.0 keV.

20. The method of claim 11, wherein the sample comprises a material containing a heavy metal element.
